(19) United States
(12) Patent Application Publication
(10) Pub. No.: US 2026/0264353 A1
(43) Pub. Date: Sep. 10, 2026

(54) TURN-UP METHOD AND TURN-UP MECHANISM

(71) Applicants: MESNAC CO., LTD., Qingdao, Shandong (CN); QINGDAO MESNAC MACHINERY & ELECTRIC ENGINEERING CO., LTD., Qingdao, Shandong (CN)

(72) Inventors: Xiaohong Xie, Qingdao, Shandong (CN); Yihang Yu, Qingdao, Shandong (CN); Xingrui Li, Qingdao, Shandong (CN); Yi Wang, Qingdao, Shandong (CN); Bin Huang, Qingdao, Shandong (CN)

(21) Appl. No.: 18/875,740

(22) PCT Filed: Jun. 16, 2023
(86) PCT No.: PCT/CN2023/100834

§ 371 Date: Dec. 17, 2024

(30) Foreign Application Priority Data
Jun. 17, 2022 (CN) 202210690241.8

(51) Int. Cl. B29D 30/26; B29D 30/32

(52) U.S. Cl. CPC B29D 30/26; B29D 2030/3214; B29D 2030/3257

(57) ABSTRACT

The present disclosure provides a turn-up method and a turn-up mechanism. The turn-up method uses a pressure roller assembly to roll a sidewall along a radial direction of a tire, and the turn-up method includes: step S1: applying, by a limiting device, a pressure within a first preset range to the pressure roller assembly, so that when the pressure roller assembly moves outward along the radial direction of the tire, the pressure roller assembly abuts against the sidewall and attaches the sidewall to the side of the tire carcass; and step S2: applying, by the limiting device, a pressure within a second preset range to the pressure roller assembly, so that the pressure roller assembly moves inward along the radial direction of the tire; where a value of the pressure within the first preset range is smaller than that of the pressure within the second preset range.

The present disclosure claims a priority from Chinese patent application No. 202210690241.8 entitled “TURN-UP METHOD AND TURN-UP MECHANISM”, which is filed with CNIPA on Jun. 17, 2022, and the entire contents of which are incorporated herein by reference.

### TECHNICAL FIELD

The present disclosure relates to the field of rubber tires, and in particular to a turn-up method and a turn-up mechanism.

### BACKGROUND

When the existing tires are turned-up built, a capsule drum is mainly used to turn up a sidewall of the tire, and the sidewall is attached by inflating the capsule, thereby avoiding a problem of tire-side indentation. However, the capsule drum has problems of cumbersome capsule replacement, high capsule cost, and poor tire bead forming quality compared with mechanical drums, resulting in a high tire defective rate and high costs.

For mechanical drums, although their cost is low, when rolling the sidewalls, there are problems such as either high rolling pressure that easily leaves indentations, or low rolling pressure that causes loose attaching of the sidewalls. Therefore, even though mechanical drums have lower costs than capsule drums, they are rarely used.

### SUMMARY

The main purpose of the present disclosure is to provide a turn-up method and a turn-up mechanism, so as to solve the problem of poor tire-sidewall attaching quality in the prior art.

In order to achieve the above-mentioned purpose, according to an optional embodiment of the present disclosure, a turn-up method is provided, a pressure roller assembly is used to roll a sidewall along a radial direction of a tire, and the turn-up method includes: step S1: applying, by a limiting device, a pressure within a first preset range to the pressure roller assembly, so that when the pressure roller assembly moves outward along the radial direction of the tire, the pressure roller assembly abuts against the sidewall and attaches the sidewall to a side surface of a carcass of the tire to cause the pressure roller assembly abut and connect with the sidewall; and step S2: applying, by the limiting device, a pressure within a second preset range to the pressure roller assembly, so that the pressure roller assembly moves inward along the radial direction of the tire; where a value of the pressure within the first preset range is smaller than a value of the pressure within the second preset range.

In an optional embodiment, the turn-up method further includes step S3 after performing the step S2, the step S3: applying, by the second turn-up structure, a pressure to the sidewall to attach the sidewall to the side surface of the carcass of the tire, where the second turn-up structure rolls both sides of the carcass simultaneously.

In an optional embodiment, the turn-up method further includes taking a limiting cylinder as the limiting device, and in step S1 and step S2, adjusting a pressure applied to the pressure roller assembly through adjusting an intake pressure of the limiting cylinder respectively in step S1 and step S2.

According to an optional embodiment of the present disclosure, a turn-up mechanism is provided, which is arranged on a spindle assembly, and includes; a plurality of first turn-up structures circumferentially arranged around the spindle assembly, and the turn-up mechanism is configured to perform the above-mentioned turn-up method, where the first turn-up structure includes: a pressure roller assembly arranged on a side of the tire for rolling the sidewall of the tire; a rolling device drivingly connected to the pressure roller assembly to move the pressure roller assembly in a radial direction of the tire; and a limiting device drivingly connected to the pressure roller assembly to apply a force to the pressure roller assembly for moving toward the tire when the tire rotates.

In an optional embodiment, the rolling device includes: a first drive rod drivingly connected to the pressure roller assembly, and the first drive assembly connected to the first drive rod to move the pressure roller assembly through the first drive rod.

In an optional embodiment, the limiting device includes: a second drive rod rotationally connected to the first drive rod, the second drive assembly connected to the second drive rod, and configured to drive the pressure roller assembly through the first drive rod to press the tire.

In an optional embodiment, the first turn-up structure further includes: a support assembly connected to the first drive rod to support the sidewall on an outside of the turn-up mechanism, where the pressure roller assembly is rotationally arranged on the support assembly or the first drive rod.

In an optional embodiment, the first turn-up structure further includes: a third drive rod, where an end of the third drive rod is rotationally connected to the support assembly, and the other end of the third drive rod is rotationally connected to the second drive rod; where the first drive rod, the support assembly, the third drive rod and the second drive rod are rotationally connected in sequence to form a four-bar linkage.

In an optional embodiment, the turn-up mechanism further includes: a second turn-up structure, where the first turn-up structure and the second turn-up structure respectively turn up and roll different positions of the sidewall, where the first turn-up structure is arranged on an inner side of the tire to roll the sidewall close to one end of the center of the tire, and the second turn-up structure is arranged on an outer side of the tire to roll the sidewall close to one end of the tire tread.

In an optional embodiment, the second turn-up structure includes: two suspension arms symmetrically arranged at intervals and configured to form a turn-up space between the two suspension arms; and a third drive assembly connected to the two suspension arms to simultaneously drive the two suspension arms to move and roll the sidewalls on both sides of the tire.

The turn-up method using the technical solution of the present disclosure adopts a pressure roller assembly to roll the sidewall along the radial direction of the tire. Alternatively, the turn-up method includes step S1 and step S2, where step S1 is when the pressure roller assembly moves outward along the radial direction of the tire, the rotation speed of the spindle assembly of the tire is low, and the centrifugal force generated by the pressure roller assembly is small, so that the limiting device applies a pressure within a first preset range to the pressure roller assembly so that the pressure roller assembly is abutted and connected with the sidewall; step S2 is when the pressure roller assembly moves inward along the radial direction of the tire, the rotation speed of the spindle assembly of the tire is high, and the centrifugal force generated by the pressure roller assembly is large. If a large pressure is not applied to the pressure roller assembly, the pressure roller assembly may be thrown out and cannot be recovered and reset. For this reason, the limiting device applies a pressure within a second preset range to the pressure roller assembly so that the pressure roller assembly can be smoothly reset; where the value of the pressure within the first preset range is smaller than the value of the pressure within the second preset range. The above operation controls the pressure in time periods and steps, so that the force of the pressure roller assembly pressing the tire side is always controlled within a preset range, avoiding the problems of indentation and incomplete sidewall attaching.

### BRIEF DESCRIPTION OF DRAWINGS

The drawings in the description, which constitute a part of the present disclosure, are used to provide a further understanding of the present disclosure. The illustrative embodiments of the present disclosure and their descriptions are used to explain the present disclosure and do not constitute an improper limitation on the present disclosure. In the figures:

FIG. 1 is a schematic structural diagram of an embodiment of a mechanical drum according to the present disclosure.

FIG. 2 is a partial structural schematic diagram of an embodiment of the turn-up mechanism of the present disclosure.

The above figures include the following reference numerals:
10. Spindle assembly; 20. First turn-up structure; 201. Pressure roller assembly; 21. First drive rod; 211. First drive assembly; 22. Second drive rod; 221. Second drive assembly; 23. Third drive rod; 24. Fourth drive rod; 25. Support assembly; 30. Second turn-up structure; 40. Lock ring structure; 50. Sidewall

### DESCRIPTION OF EMBODIMENTS

It should be noted that, in the absence of conflict, the embodiments and features in the embodiments of the present disclosure may be combined with each other. The present disclosure will be described in detail below with reference to the accompanying drawings and in combination with embodiments.

In order to solve the problem of poor attaching quality of a sidewall of a tire in the prior art, the present disclosure provides a turn-up method and a turn-up mechanism.

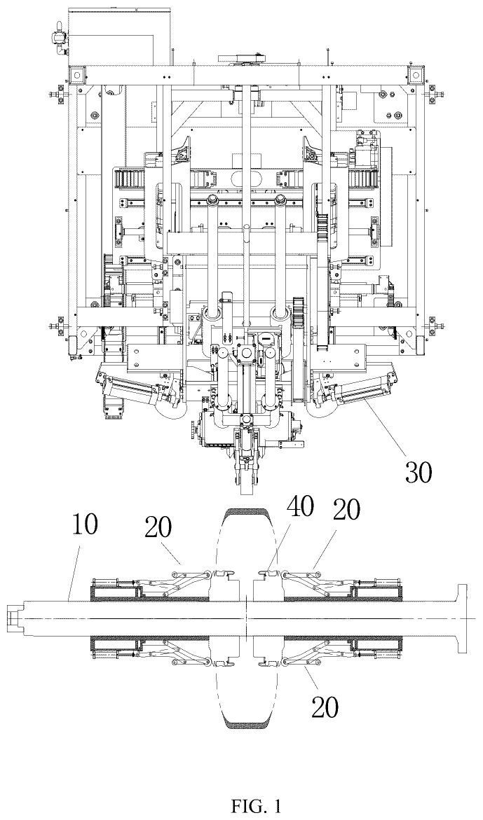

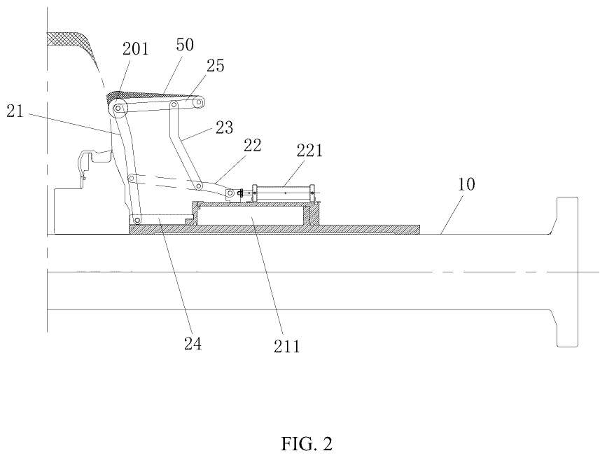

When a mechanical drum takes a pressure roller assembly 201 to perform turn-up rolling operation on a sidewall of a tire, the biggest drawback is that the pressure roller assembly 201 is likely to leave indentations during the process of rolling the sidewall, affecting the quality and appearance of the tire. If the pressure of the pressure roller assembly 201 pressing the sidewall is relatively small, it is likely that the centrifugal force will not be able to attach the sidewall during the high-speed rotation of the spindle assembly 10, thereby making it impossible for the sidewall and the carcass of the tire to attach completely. In order to solve the above problem, the roll-up method of the present disclosure uses the pressure roller assembly 201 to roll the sidewall along the radial direction of the tire. Referring to FIGS. 1 to 2, alternatively, the roll-up method includes steps S1 and S2, where step S1 is when the pressure roller assembly 21 moves outward along the radial direction of the tire, the rotation speed of the spindle assembly 10 of the tire is low, and the centrifugal force generated by the pressure roller assembly 201 is small, in order to prevent indentation of the pressure roller component 201 during rolling of the tire the pressure roller assembly 201 during rolling the sidewall, and to avoid problems such as jamming caused by excessive pressure on the carcass of the tire by the pressure roller assembly, the limiting device according to the present disclosure applies a pressure within a first preset range to the pressure roller assembly 201, so that the pressure roller assembly is abutted and connected with the sidewall; step S2 is when the pressure roller assembly 201 moves inward along the radial direction of the tire, the rotation speed of the spindle assembly 10 of the tire is high, and the centrifugal force generated by the pressure roller assembly 201 is large. If a large pressure is not applied to the pressure roller assembly 201, the pressure roller assembly 201 may be thrown out and cannot be recovered and reset. For this reason, the limiting device applies a pressure within a second preset range to the pressure roller assembly 201 so that the pressure roller assembly 201 can be smoothly reset; where the value of the pressure within the first preset range is smaller than the value of the pressure within the second preset range. The above operation controls the pressure in time periods and steps, so that the force of the pressure roller assembly 201 pressing the tire side is always controlled within a preset range, avoiding the problems of indentation and incomplete sidewall attaching.

In addition, in the turn-up method of the present disclosure, there is a situation that the rotation speed of the spindle assembly is always consistent during the turn-up process, or the rotation speed of the spindle assembly when the pressure roller assembly moves outward is greater than the rotation speed of the spindle assembly when the pressure roller assembly moves inward. At this time, under the premise of overcoming the centrifugal force, the limiting device of the present disclosure also applies a smaller force to the pressure roller assembly when the pressure roller assembly moves outward, and applies a larger force to the pressure roller assembly when the pressure roller assembly moves inward. The purpose is to first apply a smaller pressure during the process of the pressure roller assembly moving outward to make the side of the tire attach with the side surface of the carcass, and then during the process of the pressure roller assembly moving inward to reset, the limiting device applies a larger force to the pressure roller assembly to flatten the sidewall and attach closely with the carcass, while trying to prevent indentations.

In order to reduce the space occupied by the turn-up mechanism, the present disclosure limits the turn-up stroke of the first turn-up structure 20 during design. For some larger-sized tires, the first turn-up structure 20 may not be able to roll the entire sidewall when turning up the sidewall of the tire. In addition, the current sidewall still has the problem of poor attach with the carcass. For this reason, the present disclosure takes two mechanisms to roll and attach the sidewalls respectively. Alternatively, the turn-up method further includes step S3 after performing the step S2. Step S3: applying, by the second turn-up structure, a pressure to the sidewall to attach the sidewall to the side surface of the carcass of the tire, where the second turn-up structure rolls both sides of the carcass simultaneously to roll and attach the sidewall to the side surface of the tire.

In order to adjust the pressure applied to the pressure roller assembly 201, the turn-up method further includes taking a limiting cylinder as the limiting device. In step S1 and step S2, a pressure applied to the pressure roller assembly 201 is adjusted by adjusting an intake pressure of the limiting cylinder. When a higher pressure is required, a higher pressure gas is quickly filled into the limiting cylinder to apply a greater force to the pressure roller assembly 201. When a smaller force is required, the principle is the opposite.

The present disclosure further provides a turn-up mechanism for performing the above-mentioned turn-up method, the turn-up mechanism is arranged on the spindle assembly 10, and the turn-up mechanism includes a plurality of first turn-up structures 20, and the plurality of first turn-up structures 20 are arranged circumferentially around the spindle assembly 10, where the first turn-up structure 20 includes a pressure roller assembly 201, a first drive rod 21, a first drive assembly 211 and a limiting device, the pressure roller assembly 201 is configured to roll the sidewall of the tire; the first drive rod 21 is drivingly connected to the pressure roller assembly 201, the first drive assembly 211 is connected to the first drive rod 21 to move the pressure roller assembly 201 in a radial direction of the tire through the first drive rod 21; the limiting device is drivingly connected to the pressure roller assembly 201 to apply a force to the pressure roller assembly 201 for moving toward the tire when the tire rotates.

The turn-up mechanism of the present disclosure includes a plurality of first turn-up structures 20, the plurality of first turn-up structures 20 are arranged circumferentially around the spindle assembly 10. The first turn-up structure 20 includes a pressure roller assembly 201, a rolling device and a limiting device. The rolling device includes a first drive rod 21 and a first drive assembly 211. In addition, the first turn-up structure further includes a support assembly and a second drive assembly 221. The pressure roller assembly 201 is configured to directly abut against the sidewall 50 to roll the sidewall 50 of the tire, thereby pressing the sidewall 50 against the carcass of the tire; the first drive rod 21 on the rolling device is drivingly connected to the pressure roller assembly 201, and the first drive assembly 211 is connected to the first drive rod 21 to move the pressure roller assembly 201 in a radial direction of the tire by swinging the first drive rod 21; the second drive assembly 221 causes the pressure roller assembly 201 to press the tire by pushing the first drive rod 21, so that the pressure roller assembly 201 always rolls along the contour of the side surface of the carcass of the tire during the movement and maintains to abut against the carcass of the tire. At this time, the force condition of the structure is that the second drive assembly 221 directly pushes the first drive rod 21 to swing, thereby driving the upper pressure roller assembly 201 to press the carcass of the tire. The above-mentioned structural setting reduces the force transmission route, reduces the force loss, and improves the efficiency of force transmission, so that the sidewall 50 attaches more stably.

In addition, the pressure roller assembly 201 of the present disclosure is arranged on the support assembly 25. According to an embodiment, the pressure roller assembly 201 includes a roller or a pressure roller, and the roller is rotationally arranged at one end of the support assembly 25 close to the sidewall 50, and the second drive assembly 221 may directly press the sidewall 50 by pushing the pressure roller assembly 201; according to a second embodiment, the second drive assembly 221 pushes the first drive rod 21, and the first drive rod 21 is connected to the end of the support assembly 25 close to the pressure roller assembly 201, thereby pushing the pressure roller assembly 201 to press the sidewall 50; according to a third embodiment, as shown in FIG. 2, the roller is rotationally arranged at one end of the support assembly 25 close to the sidewall 50, and one end of the support assembly 25 close to the pressure roller assembly 201 is rotationally connected to the first drive rod 21, and the second drive assembly 221 is simultaneously connected to the first drive rod 21 and the support assembly 25 and applies pressure to the roller of the pressure roller assembly 201 through the first drive rod 21 and the support assembly 25 respectively so that the roller presses the sidewall 50.

After being raised, the support assembly 25 is perpendicular to the sidewall 50 of the tire or is inclined upward at an end away from the tire, so that the sidewall 50 can be supported in a better shape and the sidewall 50 pressed by the roller on the pressure roller assembly 201 can be effectively prevented from sticking to the carcass of the tire. After the turn-up rod returns, the part of the sidewall 50 away from the roller on the pressure roller assembly 201 forms a groove near the tire after the sidewall 50 is turned up due to the shrinkage of the rubber. When the subsequent suspension arm is pressed, it may wrinkle when it presses the pit. For this reason, the present disclosure arranges the roller on the pressure roller assembly 201 at one end of the support assembly 25 located at the sidewall 50, so that the pressure roller assembly 201 and the support assembly 25 are at the same distance from the center of the tire in the radial direction of the tire. When rolling, the subsequent suspension arm will continue to roll at the position where the pressure roller assembly 201 is rolled, and will not press wrinkles on the sidewall 50.

The first drive assembly 211 and the second drive assembly 221 are both driven by cylinders.

The first turn-up structure 20 further includes a second drive rod 22 and a third drive rod 23. The second drive rod 22 is connected to the second drive assembly 221, and one end of the second drive rod 22 is further rotationally connected to the first drive rod 21 to push the first drive rod 21 to swing; the other end of the third drive rod 23 is rotationally connected to an end of the support assembly 25 away from the pressure roller assembly 201, and the other end of the third drive rod 23 is further rotationally connected to the second drive rod 22; where the second drive assembly 221 moves the second drive rod 22 to simultaneously rotate the first drive rod 21 and the third drive rod 23, and the first drive rod 21 and the third drive rod 23 rotate simultaneously to rise the upper support assembly 25 so as support the unrolled tire side 50; the first drive rod 21, the support assembly 25, the third drive rod 23 and the second drive rod 22 are rotationally connected in sequence to form a four-bar linkage.

In order to realize the movement of the pressure roller assembly 201 along the side surface of the carcass of the tire, the first turn-up structure 20 of the present disclosure is further provided with a fourth drive rod 24, the fourth drive rod 24 is connected to the first drive assembly 211, and the fourth drive rod 24 is further rotationally connected to the first drive rod 21, where the first drive assembly 211 rotates the first drive rod 21 through the fourth drive rod 24, the first drive assembly 211 adopts a cylinder, the cylinder is arranged on the spindle assembly 10, and the fourth drive rod 24 is movably arranged along an axial direction of the spindle assembly 10. During operation, the cylinder pushes the fourth drive rod 24 to move along the axial direction of the spindle assembly 10, the other end of the fourth drive rod 24 is hinged to the end of the first drive rod 21, and the other end of the first drive rod 21 is abutted against the sidewall 50 through the pressure roller assembly 201, and the fourth drive rod 24 moves horizontally to push the first drive rod 21 to swing, so that the pressure roller assembly 201 is pressed on the sidewall 50 to slide, and the swinging movement form reduces the problem of the pressure roller assembly 201 getting stuck when encountering pits or protrusions on the sidewall 50.

One end of the first drive rod 21 is connected to the support assembly 25, and the other end of the first drive rod 21 is hinged to the fourth drive rod 24, where the second drive rod 22 is hinged to the part of the first drive rod 21 located between the support assembly 25 and the fourth drive rod 24, and the pressure roller assembly 201 is arranged at one end of the first drive rod 21 close to the support assembly 25 or the pressure roller assembly 201 is arranged at one end of the support assembly 25 close to the sidewall 50.

In this embodiment, the connection positions of the fourth drive rod 24, the second drive rod 22 and the support assembly 25 with the first drive rod 21 are arranged so that the pressure roller assembly 201 can smoothly and stably press the sidewall 50. Alternatively, one end of the second drive rod 22 is hinged to the first drive rod 21, and the other end of the second drive rod 22 is hinged to the second drive assembly 221, where the third drive rod 23 is hinged to the part of the second drive rod 22 located between the first drive rod 21 and the second drive assembly 221.

In order to support the unattached portion of the sidewall 50, the support assembly 25 of the present disclosure is provided with a plurality of support rods, and the plurality of support rods are arranged at intervals in a direction perpendicular to the sidewall 50 to support the drooping sidewall 50 as much as possible, where the first turn-up structure 20 further includes a plurality of rollers, and the plurality of roller barrels are arranged in a one-to-one correspondence on each support rod, where the roller barrels are rotationally sleeved on the support rods so that the sidewall 50 can slide.

In order to better enable the pressure roller assembly 201 to roll the sidewall 50 smoothly, according to the present disclosure, the pressure roller assembly 201 is rotationally arranged on the first drive rod 21 or the support assembly 25. Alternatively, the pressure roller assembly 201 includes an annular pressure roller, and the roller is arranged at the end of the first drive rod 21, or the pressure roller is sleeved on the support rod of the support assembly 25 close to one end of the sidewall 50.

In addition, since the space of the entire turn-up mechanism is reduced, the stroke of the first turn-up structure 20 is limited in this embodiment, and a two-stage turn-up form is adopted. Alternatively, the turn-up mechanism further includes a second turn-up structure 30, where the first turn-up structure 20 is arranged on the inner side of the tire, and the second turn-up structure 30 is arranged on the outer side of the tire. The first turn-up structure 20 and the second turn-up structure 30 respectively turn up and roll different positions of the sidewall 50, and the part of the side surface of the carcass near the center of the tire is rolled and attached by the first turn-up structure 20, and the part of the side surface of the carcass near the outer side of the tire is rolled and attached by the second turn-up structure 30.

The second turn-up structure 30 includes two suspension arms and a third drive assembly. The two suspension arms are symmetrically and arranged at intervals. The two suspension arms may be arranged close to or far away from each other. A turn-up space is formed between the two suspension arms. When the suspension arms are close to each other, the ends of the suspension arms are attached to the sidewall 50, and the sidewall 50 is attached to the side surface of a carcass of the tire by rolling. The third drive assembly is connected to both suspension arms. The third drive assembly uses a cylinder to simultaneously move the two suspension arms and roll the sidewalls 50 on both sides of the tire.

The present disclosure further provides a mechanical drum, which includes a spindle assembly 10 and two turn-up mechanisms, the two turn-up mechanisms are symmetrically arranged on the spindle assembly 10, and the two turn-up structures roll the sidewalls on both sides of the tire respectively, where the turn-up mechanism is the above-mentioned turn-up mechanism. The mechanical drum abandons the existing bladder reverse packaging form, and forms a rolling pressure on the tire side 50 through a cylinder, a connecting rod mechanism and a pressure roller assembly 201, which extends a service life and saves costs.

In addition, the mechanical drum of the present disclosure further includes a locking ring structure 40. There are two locking ring structures 40, which are symmetrically arranged on the spindle assembly and located between the two turn-up mechanisms, and are configured to lock the tire bead, thereby fixing the carcass of the tire.

From the above description, it may be seen that the above embodiments of the present disclosure achieve the following technical effects:

The above-mentioned turn-up mechanism of the present disclosure realizes the pressure regulation control of the pressure roller assembly. Alternatively, when the pressure roller moves upward along the sidewall, the pressure of the limiting cylinder is small; when the pressure roller moves downward along the sidewall, the pressure is increased. When the suspension arm enters, the drum rotates at high speed and the centrifugal force is large. At this time, the pressure of the limiting cylinder is also large.

During the turn-up operation of the conventional mechanical drum, when the pressure roller assembly is upward, if the pressure of the limiting cylinder is too high, the pressure roller assembly cannot rise, so the pressure should be smaller at this time. If the pressure is too high at this time, the indentation on the sidewall will be deeper, affecting the quality. When falling back, the pressure needs to be larger to overcome the centrifugal force and retract the pressure roller assembly.

The above description is only a preferred embodiment of the present disclosure and is not intended to limit the present disclosure. For those skilled in the art, the present disclosure may have various modifications and changes. Any modifications, equivalent substitutions, improvements, etc. made within the spirit and principles of the present disclosure should be included in the protection scope of the present disclosure.

1. A turn-up method, in which a pressure roller assembly (201) is used to roll a sidewall (50) along a radial direction of a tire, characterized in that the turn-up method comprises:
step S1: applying, by a limiting device, a pressure within a first preset range to the pressure roller assembly (201), so that when the pressure roller assembly (201) moves outward along the radial direction of the tire, the pressure roller assembly (201) abuts against the sidewall (50) and attaches the sidewall (50) to a side surface of a carcass of the tire; and
step S2: applying, by the limiting device, a pressure within a second preset range to the pressure roller assembly (201), so that the pressure roller assembly (201) moves inward along the radial direction of the tire;
wherein a value of the pressure within the first preset range is smaller than a value of the pressure within the second preset range.

2. The turn-up method of claim 1, further comprising step S3 after performing the step S2,
the step S3: applying, by a second turn-up structure (30), a pressure to the sidewall (50) to attach the sidewall (50) to the side surface of the carcass of the tire, wherein the second turn-up structure (30) rolls both sides of the carcass simultaneously.

3. The turn-up method of claim 1, further comprising taking a limiting cylinder as the limiting device, adjusting a pressure applied to the pressure roller assembly (201) through adjusting an intake pressure of the limiting cylinder respectively in step S1 and step S2.

4. A turn-up mechanism, which is arranged on a spindle assembly (10), and comprises a plurality of first turn-up structures (20) circumferentially arranged around the spindle assembly (10), characterized in that the turn-up mechanism is configured to perform the turn-up method of claim 1, wherein the first turn-up structure (20) comprises:
a pressure roller assembly (201) arranged on a side of the tire for rolling the sidewall of the tire (50);
a rolling device drivingly connected to the pressure roller assembly (201) to move the pressure roller assembly (201) in a radial direction of the tire; and
a limiting device drivingly connected to the pressure roller assembly (201) to apply a force to the pressure roller assembly (201) for moving toward the tire when the tire rotates.

5. The turn-up mechanism of claim 4, characterized in that the rolling device comprises:
a first driving rod (21) drivingly connected to the pressure roller assembly (201); and
a first driving assembly (211) connected to the first driving rod (21) to move the pressure roller assembly (201) through the first driving rod (21).

6. The turn-up mechanism of claim 5, characterized in that the limiting device comprises:
a second driving rod (22) rotationally connected to the first driving rod (21); and
a second driving assembly (221) connected to the second driving rod (22) and configured to drive the pressure roller assembly (201) through the first driving rod (21) to press the tire.

7. The turn-up mechanism of claim 6, characterized in that the first turn-up structure (20) further comprises:
a support assembly (25) connected to the first drive rod (21) to support the sidewall (50) on an outside of the turn-up mechanism, wherein the pressure roller assembly (201) is rotationally arranged on the support assembly (25) or the first drive rod (21).

8. The turn-up mechanism of claim 7, characterized in that the first turn-up structure (20) further comprises:
a third driving rod (23), wherein an end of the third driving rod (23) is rotationally connected to the support assembly (25), and the other end of the third driving rod (23) is rotationally connected to the second driving rod (22);
wherein the first driving rod (21), the support assembly (25), the third driving rod (23) and the second driving rod (22) are rotationally connected in sequence to form a four-bar linkage.

9. The turn-up mechanism of claim 4, characterized in that the turn-up mechanism further comprises: a second turn-up structure (30), wherein the first turn-up structure (20) and the second turn-up structure (30) respectively turn up and roll the sidewall (50), wherein the first turn-up structure (20) is arranged on the spindle assembly (10), and the second turn-up structure (30) is arranged on a side of the spindle assembly (10).

10. The turn-up mechanism of claim 9, characterized in that the second turn-up structure (30) comprises:
two suspension arms symmetrically arranged at intervals and configured to form a turn-up space between the two suspension arms; and
a third drive assembly connected to the two suspension arms to simultaneously drive the two suspension arms to move and roll the sidewalls (50) on both sides of the tire.

11. The turn-up method of claim 2, further comprising taking a limiting cylinder as the limiting device, adjusting a pressure applied to the pressure roller assembly (201) through adjusting an intake pressure of the limiting cylinder respectively in step S1 and step S2.
